(19) United States
(12) Patent Application Publication
(10) Pub. No.: US 2010/0325360 A1
(43) Pub. Date: Dec. 23, 2010

(54) MULTI-CORE PROCESSOR AND MULTI-CORE PROCESSOR SYSTEM

(75) Inventors: Yumi Yoshitake, Tokyo (JP); Shunsuke Sasaki, Tokyo (JP)

Correspondence Address: SPRINKLE IP LAW GROUP, 1301 W. 25TH STREET, SUITE 408, AUSTIN, TX, 78705, US

(73) Assignee: Kabushiki Kaisha Toshiba, Tokyo (JP)

(21) Appl. No.: 12/813,567

(22) Filed: Jun. 11, 2010

(30) Foreign Application Priority Data
Jun. 19, 2009 (JP) 2009-146587

(51) Int. Cl. G06F 12/08

(52) U.S. Cl. 711/125; 711/E12.017

(57) ABSTRACT

In one embodiment, a multi-core processor includes a plurality of processor cores that each includes a cache and that uses a management target area allocated as a main memory in a memory area. The multi-core processor includes a state managing unit and a management-target-area. The state managing unit manages a first state in which the small area is not allocated to the processor core and a second state in which the small area is allocated to the processor core for each small area included in the management target area. The management-target-area increasing and decreasing unit increases and decreases the management target area by increasing and decreasing the small area in the first state in the management target area.

### CROSS-REFERENCE TO RELATED APPLICATIONS

This application is based upon and claims the benefit of priority from Japanese Patent Application No. 2009-146587, filed Jun. 19, 2009; the entire contents of which are incorporated herein by reference.

### FIELD

The present invention relates to multi-core processor and a multi-core processor system.

### BACKGROUND

In a document “Toshiba's Next-Generation SoC “Venezia” Adopts Homogeneous Multicore” Nikkei Electronics, Nikkei Business Publications, Inc., vol. 981, Jun. 30, 2008, p. 111 and pp. 113-114, written by Yoshiro Tsuboi, Yutaka Ohta, and Takahiro Yamashita, (hereinafter, Non-Patent Document 1), a technology is disclosed in which a function of maintaining cache coherency is implemented by software rather than a hardware mechanism for suppressing increase in chip area and power consumption. With this technology, a protocol is defined in a memory access and a state is given to a memory, and an access to a memory determined for each state is permitted to maintain the cache coherency. However, this method has a problem in that a memory area that can be used as a main memory by a multi-core processor cannot be dynamically added and removed.

### BRIEF DESCRIPTION OF THE DRAWINGS

FIG. 1 is a diagram illustrating a configuration of a multi-core processor system according to a first embodiment;

FIG. 2 is a diagram explaining a memory access protocol in a conventional technology;

FIG. 3 is a diagram explaining a state in which memory resources included in a management target area are allocated to tasks;

FIG. 4 is a diagram explaining an operation of a memory reservation;

FIG. 5 is a diagram explaining an operation of a memory deallocation;

FIG. 6 is a diagram explaining a memory access protocol according to the first embodiment;

FIG. 7 is a diagram explaining a function configuration of the multi-core processor system according to the first embodiment;

FIG. 8 is a diagram explaining a data structure of memory allocation management information;

FIG. 9 is a flowchart explaining an example of a state transition;

FIG. 10 is a sequence diagram explaining a procedure for obtaining permission to add the management target area;

FIG. 11 is a sequence diagram explaining a procedure for obtaining permission to remove the management target area;

FIG. 12 is a flowchart explaining an operation of adding the memory area to the management target area;

FIG. 13 is a flowchart explaining an operation of removing the memory area from the management target area;

FIG. 14 is a diagram explaining an extended memory access protocol;

FIG. 15 is a diagram illustrating a configuration of a multi-core processor system according to a second embodiment; and

FIG. 16 is a diagram explaining a function configuration of the multi-core processor system according to the second embodiment.

### DETAILED DESCRIPTION

In one embodiment, a multi-core processor includes a plurality of processor cores that each includes a cache and that uses a management target area allocated as a main memory in a memory area. The multi-core processor includes a state managing unit and a management-target-area. The state managing unit manages a first state in which the small area is not allocated to the processor core and a second state in which the small area is allocated to the processor core for each small area included in the management target area. The state managing unit further classifies the small area in the second state into a plurality of states in which permission and non-permission of an access and permission and non-permission of use of the cache at a time of an access are defined. The state managing unit manages a transition between classified states. The management-target-area increasing and decreasing unit increases and decreases the management target area by increasing and decreasing the small area in the first state in the management target area.

A multi-core processor and a multi-core processor system according to embodiments of the present invention are explained in detail below with reference to the accompanying drawings. The present invention is not limited to these embodiments.

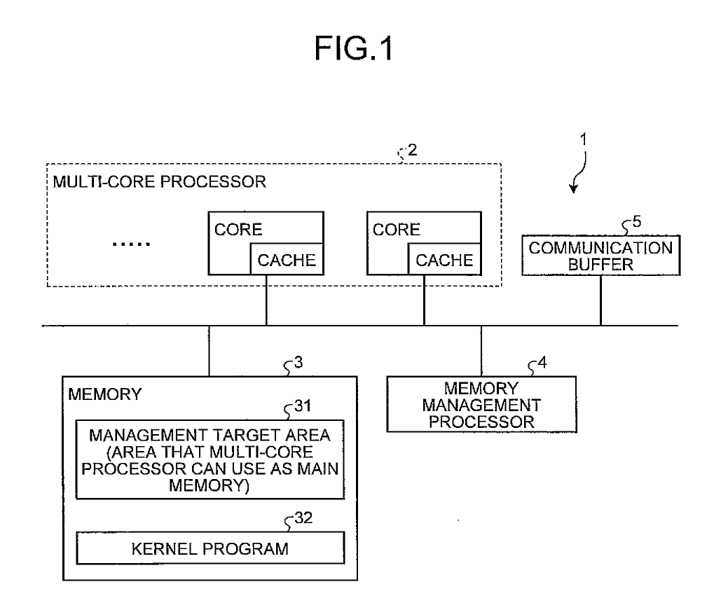

FIG. 1 is a block diagram illustrating a configuration of a multi-core processor system according to a first embodiment of the present invention.

As shown in FIG. 1, a multi-core processor system 1 includes a multi-core processor 2, a memory 3, a memory management processor 4, and a communication buffer 5. These components (the multi-core processor 2, the memory 3, the memory management processor 4, and the communication buffer 5) are connected with each other via a bus. The configuration can be such that these components are connected with each other in other network topologies such as mesh instead of the bus.

The multi-core processor 2 includes a plurality of cores for executing a task, and each core includes a cache.

The memory 3, for example, includes a Random Access Memory (RAM). In the memory 3, a management target area 31 is reserved. The management target area 31 is an area from which a work area that is used by a core included in the multi-core processor 2 at a time of executing a task is sequentially allocated to the core, i.e., an area that the multi-core processor 2 can use as a main memory. Moreover, a kernel program 32 that is a program for managing the multi-core processor 2 is loaded in the memory 3. The multi-core processor 2 allocates a memory area in the management target area 31 to each core while maintaining cache coherency by executing the kernel program 32. In the following explanation, the operations expressed with the multi-core processor 2 as a main component are realized by the multi-core processor 2 executing the kernel program 32. These operations are explained with the kernel program 32 as a main component in some cases instead of the multi-core processor 2. The load source of the kernel program 32 can be a nonvolatile memory area that, for example, includes a Read Only Memory (ROM), an external storage, or the like, in which the program is stored in advance.

The memory management processor 4 is a dedicated processor for management of the whole memory resources of the memory 3. A specific function of the memory management processor 4 is explained later.

The communication buffer 5 is a dedicated buffer for communication between the multi-core processor 2 and the memory management processor 4.

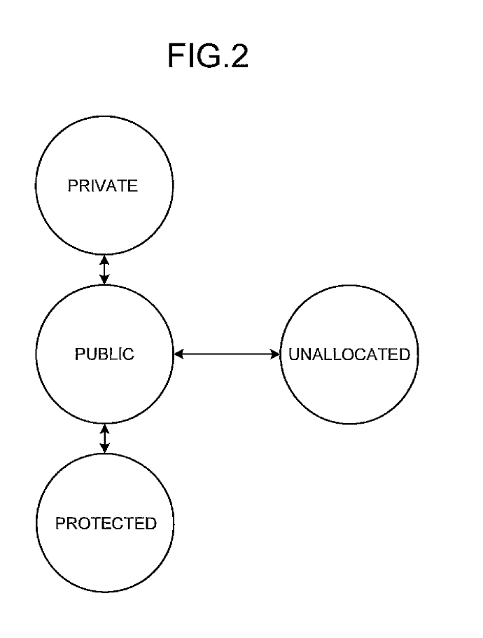

Next, explanation is given for the technology (hereinafter, simply, conventional technology) for maintaining the cache coherency disclosed in Non-Patent Document 1 before explaining the function configuration in the first embodiment of the present invention. This conventional technology is incorporated in the first embodiment, so that explanation is given by using the configuration and the symbols shown in FIG. 1 for easy understanding. As described above, in the conventional technology, the cache coherency is maintained by software rather than hardware. A Memory Access Protocol (MAP) as shown in FIG. 2 is defined and an access to the management target area 31 for all of tasks (the processor cores that execute the tasks to be exact) strictly conforms to this protocol for maintaining the cache coherency with software.

In the MAP in the conventional technology, as shown in FIG. 2, the following four states are defined.

### (1) UNALLOCATED State

A state in which allocation to a task is not performed by the kernel program 32 and the allocation is possible is defined as the UNALLOCATED state. Specifically, the state before memory allocation and after memory deallocation belongs to this state.

### (2) PRIVATE State

A state in which only a task transitioned to this state is permitted to perform a read/write access using the cache (i.e., the cache included in the core) is defined as the PRIVATE state.

### (3) PUBLIC State

A state in which the read/write access without using the cache is permitted to all of tasks is defined as the PUBLIC state.

### (4) PROTECTED State

A state in which only a task transitioned to this state can perform the access using the cache only in the read access is defined as the PROTECTED state. The write access to an area in this state is impossible.

In this manner, in the MAP, the states of the memory resources are classified into the state (UNALLOCATED state) in which the memory resource is not allocated to a task and the states in which the memory resource is allocated to a task, and the states in which the memory resource is allocated to a task are further classified into a plurality of the states (the PRIVATE state, the PUBLIC state, and the PROTECTED state) in which permission and non-permission of the read/write access and permission and non-permission of use of the cache included in the processor core at the time of the access are defined.

Transition is possible between the four states in directions indicated by arrows. In other words, the transition is possible between the UNALLOCATED state and the PUBLIC state. The PUBLIC state can also be transitioned to the PRIVATE state and the PROTECTED state in addition to the UNALLOCATED state. The cache coherency is maintained by following the memory access based on the definition of each state and the relationship of the state transition in this manner.

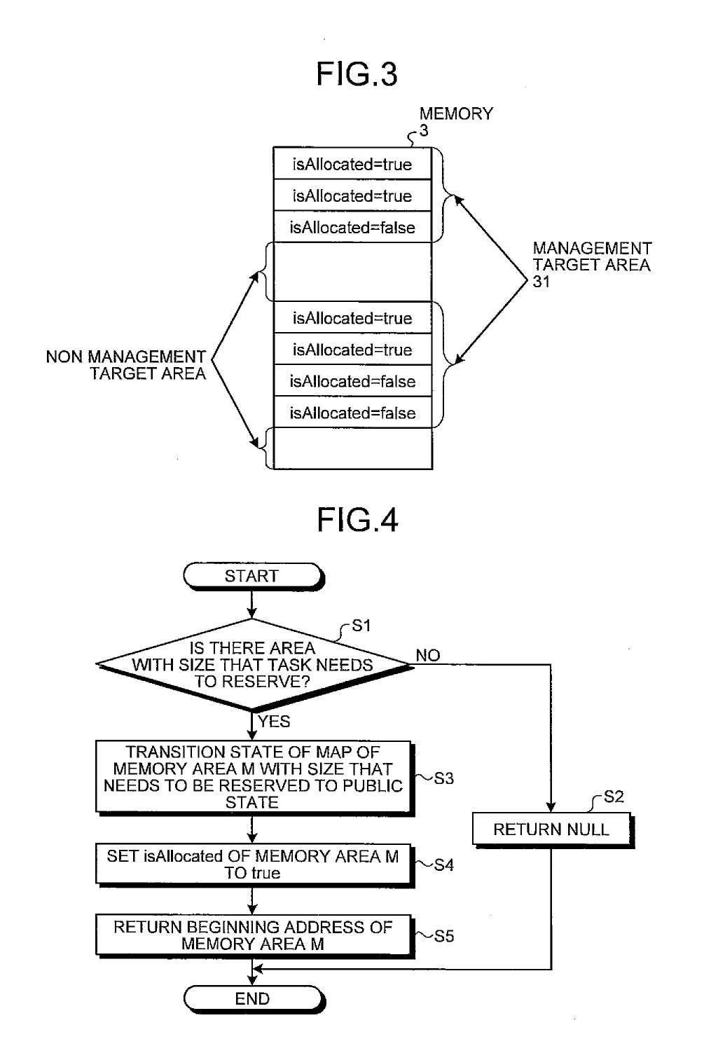

Each state transition is performed by calling a function provided by the kernel program 32. The function to be called is individually defined by the state before the transition and the state after the transition. A beginning address and a size of a memory area that needs to be transitioned are used as an argument for each function. When the state of the memory area given as the argument does not correspond to the function, it can be detected in the function. Then, an operation necessary for transitioning the state is performed. For example, in the case of transitioning from the PRIVATE state, the cache is written back to the memory. FIG. 3 is a diagram explaining a state in which the memory resources included in the management target area 31 are allocated to tasks. The memory resources in the management target area 31 are managed in a predetermined unit. In an area in each unit size of the management target area 31, a binary variable is Allocated indicating whether the area is allocated to a task is defined. The is Allocated variable is used mainly for searching for an area that is not allocated to a task in the management target area 31. A task is already allocated to the area in which the is Allocated variable is “true”, and one of the PRIVATE state, the PUBLIC state, and the PROTECTED state is set to the area. A task is not allocated to the area in which the is Allocated variable is “false”, and the UNALLOCATED state is set to the area. The area other than the management target area 31 is not under the management of the kernel program 32, and the is Allocated variable is not defined. When there is a request for a memory reservation or deallocation from a task, the kernel program 32 calls the function to be explained next and transitions the state of the MAP to an appropriate state.

(1) allocate (size_t size, State state)

This function is called when there is a request for the memory reservation from a task. FIG. 4 is a flowchart explaining the operation of the memory reservation by calling and executing the allocate function. As shown in FIG. 4, when the request for the memory reservation is received from a task, first, the multi-core processor 2 (the kernel program 32) determines whether there is a continuous memory areas (memory area M) with a size (the size passed as an argument “size_t” of the allocate function) that the task need to reserve in the management target area 31 with the is Allocated variable as a key (Step S1). When there is not the memory area M (No at Step S1), the multi-core processor 2 returns a zero value (NULL) to the task (Step S2) and ends the operation. When there is the memory area M (Yes at Step S1), the multi-core processor 2 calls and executes the function that performs the transition from the UNALLOCATED state to a desired state (argument “State”, the PUBLIC in this example) to transition the state of the MAP of the memory area with the size that needs to be reserved to the PUBLIC state (Step S3) and sets the is Allocated variable to “true” (Step S4). Then, the multi-core processor 2 returns the beginning address of the transitioned area to the task (Step S5) and ends the operation.

(2) free (void *adr, size_t size, State state)

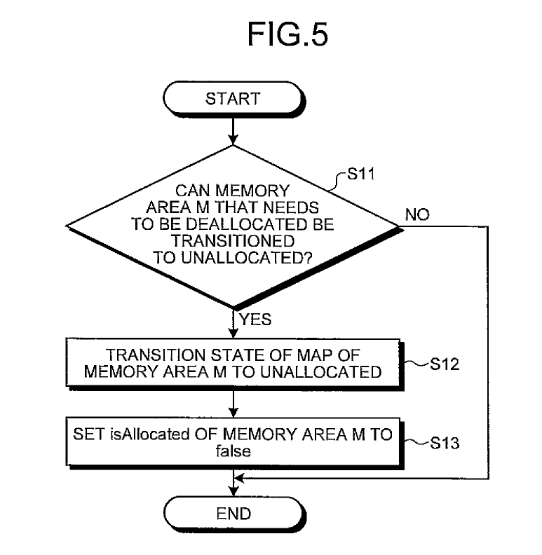

This function is called when there is a request for the memory deallocation from a task. FIG. 5 is a flowchart explaining the operation of the memory deallocation by calling and executing the free function. As shown in FIG. 5, when the request for the memory deallocation is received from the task, the multi-core processor 2 determines whether the memory area (the memory area (memory area M) that is specified by the beginning address passed in an argument “adr” and a size passed in an argument “size_t” of the free function) that needs to be deallocated can be transitioned from the current state passed in an argument “State” to the UNALLOCATED state (Step S11). When the multi-core processor 2 determines that the state passed in the argument “State” is not the PUBLIC state and cannot be transitioned to the UNALLOCATED state (No at Step S11), the multi-core processor 2 ends the operation. When the multi-core processor 2 determines that the state passed in the argument “State” is the PUBLIC state and can be transitioned to the UNALLOCATED state (Yes at Step S11), the multi-core processor 2 calls and executes the function that performs the transition from the PUBLIC state to the UNALLOCATED state, thereby transitioning the state of this target memory area to the UNALLOCATED state (Step S12).

Then, the multi-core processor 2 sets the is Allocated variable of this transitioned target memory area to “false” (Step S13) and ends the operation.

The transition between the PUBLIC state and the PRIVATE state and between the PUBLIC state and the PROTECTED state is performed by the kernel program 32 calling and executing the function corresponding to the transition in accordance with the request from a task.

In this manner, the kernel program 32 manages which memory area is allocated and calls the function that transitions the state of the MAP in accordance therewith. Then, a task accesses the management target area 31 based on the state of the memory area to be accessed, thereby enabling to maintain the coherency (cache coherency) between the cache included in the core and the management target area 31 as the main memory area.

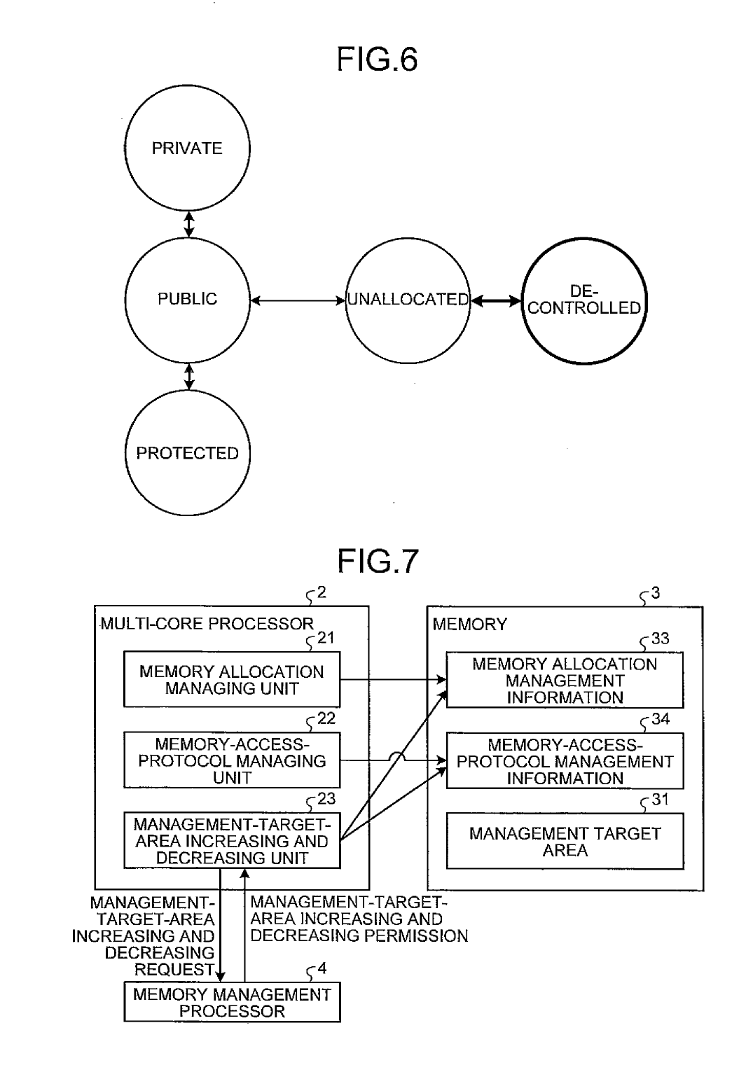

However, the area that is not allocated to a task in the memory area included in the management target area 31 may be insufficient or may remain excessively. In the above conventional technology, the kernel program 32 cannot recognize the device that manages the area other than the management target area 31. Therefore, it is impossible to reduce the management target area 31 so that the excess area that is not allocated to the task can be used other than the kernel program 32 or to add the management target area 31 when the area that is not allocated to the task becomes insufficient. In other words, the memory usage efficiency is low. On the contrary, the first embodiment is mainly characterized in that, as shown in FIG. 6, a DECONTROLLED state, which defines the state that is for the area other than the management target area 31 and can be changed to the management target area 31, is added to the MAP of the conventional technology, and the memory area in the UNALLOCATED state is increased and decreased by operating the transition between the DECONTROLLED state and the UNALLOCATED state, thereby enabling to increase and decrease the management target area 31.

FIG. 7 is a diagram explaining a function configuration of the multi-core processor system 1 for realizing the above described characteristics. As shown in FIG. 7, the multi-core processor 2 generates a memory allocation managing unit 21, a memory-access-protocol managing unit 22, and a management-target-area increasing and decreasing unit 23 by executing the kernel program 32.

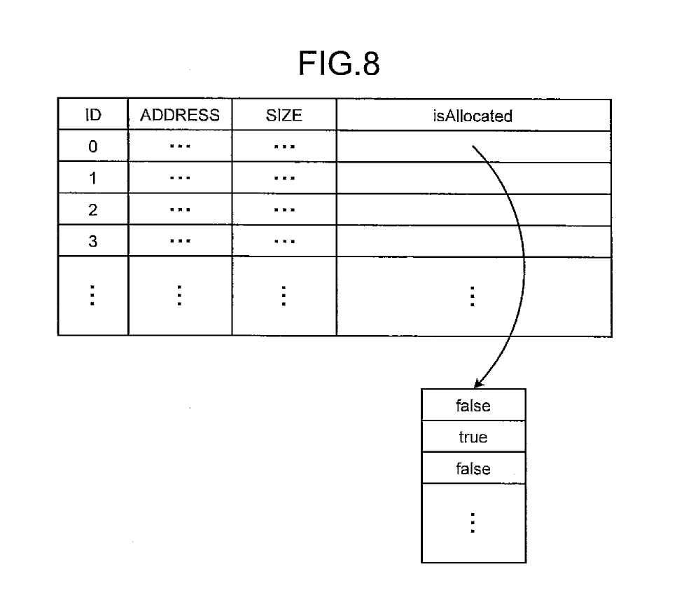

The memory allocation managing unit 21 is a function unit that changes the state of the is Allocated variable defined in the memory resources in the management target area 31. Specifically, the memory allocation managing unit 21 includes the allocate function and the free function, and a function of calling and executing a desired function from among this group in accordance with the request from a task. The allocate function and the free function operate memory allocation management information 33 that indicates the state of the is Allocated variable of the memory resources in the management target area 31. FIG. 8 is a diagram explaining an example of the data structure of the memory allocation management information 33.

In FIG. 8, the management target area 31 having one continuous address is defined with the beginning address indicated in a column “address” and the size of the area indicated in a column “size” in the memory allocation management information 33. When a plurality of the management target areas 31 each having a continuous address is present, a plurality of sets of the “address” and the “size” is defined. A column “ID” is an identifier for distinguishing between a plurality of sets of the defined continuous management target areas 31. In a column “is Allocated”, the value of the is Allocated variable defied for each memory area of a predetermined unit size is written for each continuous management target area 31. In this example, the is Allocated variable of the memory area of the management target area 31 of “ID0” indicates “false”, “true”, “false”, . . . from the beginning.

Returning to FIG. 7, the memory-access-protocol (MAP) managing unit 22 is a function unit for managing the state of the memory resources in the management target area 31, and specifically indicates the functions that are called for performing transition between the UNALLOCATED state and the PUBLIC state, the PUBLIC state and the PRIVATE state, and the PUBLIC state and the PROTECTED state explained in the conventional technology and a function of calling and executing a desired function from among this function group in accordance with a request from a task. This function group operates memory-access-protocol (MAP) management information 34 that is information indicating the current state of the memory resources in the management target area 31. Specifically, the MAP management information 34 further classifies the state of the memory area into one of the three states of the PUBLIC state, the PRIVATE state, and the PROTECTED state for each memory area of which is Allocated variable is “true” and stores them. Moreover, the MAP management information 34 stores the state of the area of which is Allocated variable is “false” as the UNALLOCATED state.

The location in which the memory allocation management information 33 and the MAP management information 34 are stored is not specifically limited so long as the multi-core processor 2 can perform the read/write access to the storage area. In this example, the memory allocation management information 33 and the MAP management information 34 are stored in the memory 3. In the case where the memory 3 consists of a volatile memory with no backup power source, the management target area 31 is lost when the power is turned off. At this time, the configuration can be such that the memory allocation management information 33 and the MAP management information 34 are also lost together with the management target area 31 and are generated by the kernel program 32 when the power is turned on. Moreover, when the configuration is such that data in the management target area 31 is saved to the nonvolatile storage area when the power is turned off, the memory allocation management information 33 and the MAP management information 34 can also be saved together with the data in the management target area 31.

In this example, the area other than the management target area 31 is implicitly set to the DECONTROLLED state and the area in the DECONTROLLED state is not managed explicitly in the MAP management information 34; however, the MAP management information 34 can store the area other than the management target area 31 as the area in the DECONTROLLED state.

The management-target-area increasing and decreasing unit 23 increases and decreases the management target area 31. Specifically, the management-target-area increasing and decreasing unit 23 increases and decreases the management target area 31 by executing the function that performs the transition between the newly-added DECONTROLLED state and the UNALLOCATED state and the function that generates/removes the is Allocated variable. The function that generates/removes the is Allocated variable is explained below.

(1) add_control_memory_field (void *addr, size_t size)

This function generates the is Allocated variable of the memory area defined by the beginning address that the argument “adr” indicates and the size that the argument “size” indicates, and assigns “false” to the generated is Allocated variable. More specifically, this function adds an entry of the address that the argument “adr” indicates and the size that the argument “size” indicates to the memory allocation management information 33, and sets all of the values of the is Allocated variable of the memory area in a unit size written in the column “is Allocated” of the added entry to “false”.

(2) remove_control_memory_field (void *addr, size_t size)

This function removes the is Allocated variable of the memory area defined by the beginning address that the argument “adr” indicates and the size that the argument “size” indicates. Specifically, this function removes the description for the memory area defined by the beginning address that the argument “adr” indicates and the size that the argument “size” indicates from the management target area 31 defined in the memory allocation management information 33.

The management-target-area increasing and decreasing unit 23 preferably determines whether to increase and decrease the management target area 31 in accordance with the size of the memory area in the UNALLOCATED state. For example, when the memory area in the UNALLOCATED state is expected to become insufficient, the management-target-area increasing and decreasing unit 23 can increase the management target area 31. Moreover, when the memory area in the UNALLOCATED state remains excessively and this excess memory area is expected not to be used for a while, the management-target-area increasing and decreasing unit 23 can decrease the management target area 31.

The management-target-area increasing and decreasing unit 23 transmits the request (management-target-area increasing and decreasing request) for increasing and decreasing the management target area 31 to the memory management processor 4 before increasing and decreasing the management target area 31. As described above, the memory management processor 4 is a dedicated processor for management of the whole memory resources of the memory 3 and stores information indicating which area is under the management of which device. For example, the memory management processor 4 stores information indicating that the management target area 31 is placed under the management of the multi-core processor 2 (the kernel program 32 to be exact). In other words, the memory management processor 4 has a function of allocating the memory resources of the memory 3 to the management target area 31. When the memory management processor 4 receives the management-target-area increasing and decreasing request from the management-target-area increasing and decreasing unit 23, the memory management processor 4 determines whether the received request can be permitted. When the memory management processor 4 determines that the received request can be permitted, the memory management processor 4 transmits a management-target-area increasing and decreasing permission indicating that the increasing and decreasing of the management target area is permitted to the management-target-area increasing and decreasing unit 23. After receiving the management-target-area increasing and decreasing permission, the management-target-area increasing and decreasing unit 23 increases and decreases the management target area 31. The management-target-area increasing and decreasing request and the management-target-area increasing and decreasing permission are transmitted and received between the management-target-area increasing and decreasing unit 23 and the memory management processor 4 via the communication buffer 5.

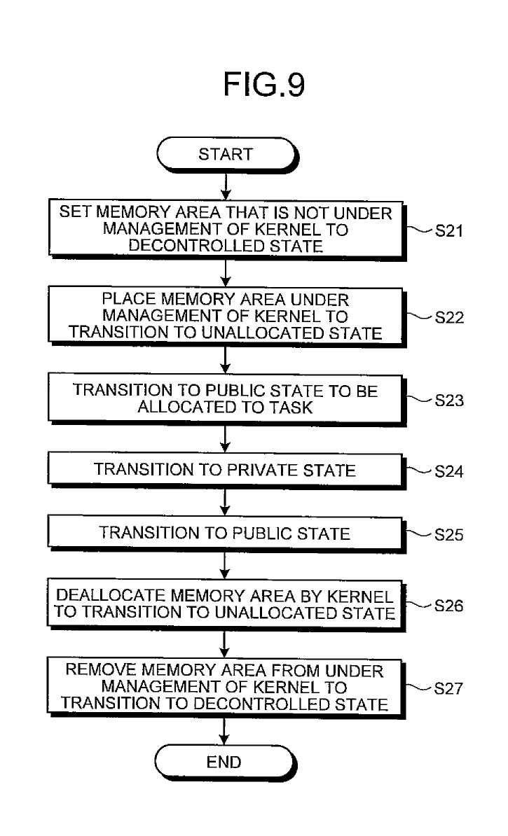

Next, the operation of the multi-core processor system 1 in the first embodiment is explained. First, as a summary of the operation, an example of the state transition is explained. FIG. 9 is a flowchart explaining an example of the state transition of a memory area.

As shown in FIG. 9, the memory area is in the DECONTROLLED state that indicates that the memory area is not managed by the kernel program 32 (Step S21). In other words, this memory area is not included in the management target area 31. Next, the memory area is placed under the management of the kernel program 32, and the state of the MAP of this memory area is transitioned to the UNALLOCATED state by the operation of the management-target-area increasing and decreasing unit 23 (Step S22). In other words, this memory area is added to the management target area 31. Next, when the memory allocation request is input from a task to the kernel program 32, the state of this memory area is transitioned to the PUBLIC state that is the state requested by the task by the operation of the MAP managing unit 22 and this memory area is allocated to the task (Step S23). Thereafter, the task calls and executes the corresponding function included in the MAP managing unit 22, so that this memory area is transitioned to the PRIVATE state and then the PUBLIC state (Step S24 and Step S25), and the task requests the MAP managing unit 22 to perform the memory deallocation. When the deallocation request is notified, the MAP managing unit 22 transitions the state of the MAP to the UNALLOCATED state (Step 526). Then, when this memory area is removed from under the management of the kernel program 32, the management-target-area increasing and decreasing unit 23 transitions the state of this memory area to the DECONTROLLED state (Step 527). In other words, the management-target-area increasing and decreasing unit 23 removes this memory area from the management target area 31.

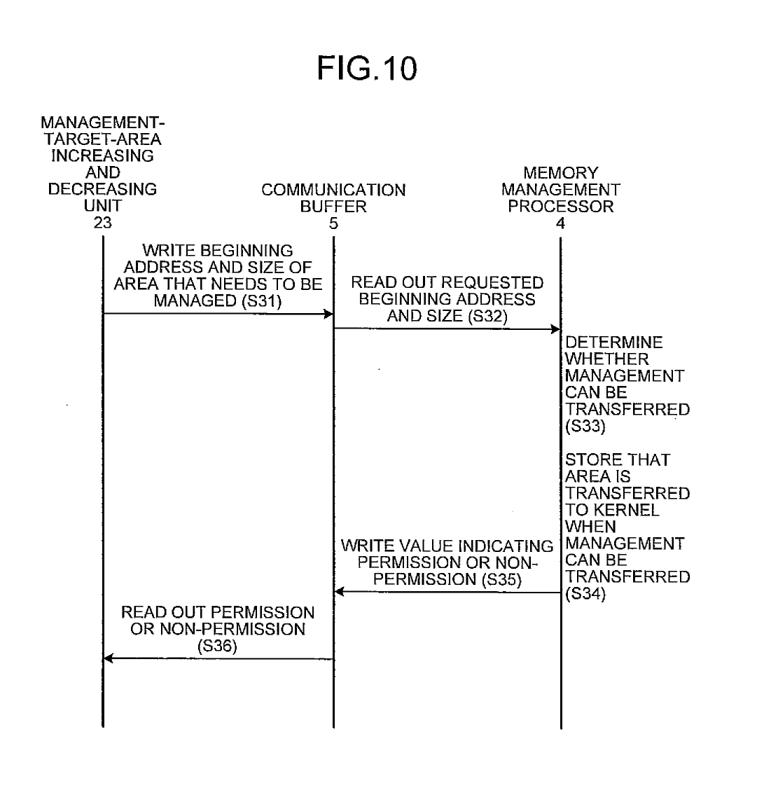

Next, the operation when the management-target-area increasing and decreasing unit 23 adds/removes the management target area 31 is explained. FIG. 10 is a sequence diagram explaining a procedure for obtaining permission for adding the management target area when adding the management target area. As shown in FIG. 10, the management-target-area increasing and decreasing unit 23 writes information (the beginning address and the size) on the memory area that needs to be reserved as a request for increasing the management target area 31 in the communication buffer 5 (Step S31). The communication buffer 5 notifies the memory management processor 4 that the writing of the request is made, and the memory management processor 4 that receives the notification reads out the beginning address and the size of the memory area requested to add to the management target area 31 from the communication buffer 5 (Step S32). The memory management processor 4 determines whether the request can be permitted (Step S33). When the request can be permitted, the memory management processor 4 stores information indicating that the memory area is added to the management target area 31, i.e., the memory area is placed under the management of the kernel program 32 (Step S34), and writes that the request is permitted as the management-target-area increasing and decreasing permission in the communication buffer 5 (Step S35). When the request cannot be permitted at Step S33, the memory management processor 4 writes that effect at Step S35. Then, the communication buffer 5 notifies the management-target-area increasing and decreasing unit 23 that the permission/non-permission is written, and the management-target-area increasing and decreasing unit 23 that receives the notification reads out the permission/non-permission and recognizes the result for the request for adding the memory area (Step S36).

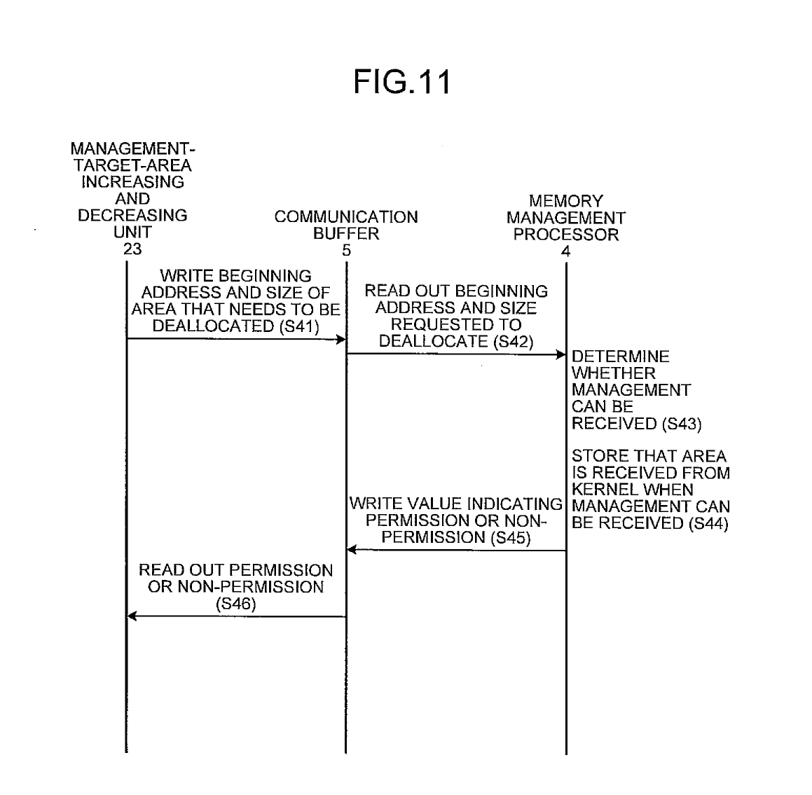

FIG. 11 is a sequence diagram explaining a procedure for obtaining permission for removing the management target area when removing the management target area. As shown in FIG. 11, the management-target-area increasing and decreasing unit 23 writes information (the beginning address and the size) on the memory area that needs to be removed (deallocated) in the management target area 31 as a request for removing the management target area 31 in the communication buffer 5 (Step S41). The communication buffer 5 notifies the memory management processor 4 that the writing of the request is made, and the memory management processor 4 that receives the notification reads out the beginning address and the size of the memory area requested to remove from the management target area 31 from the communication buffer 5 (Step S42). The memory management processor 4 determines whether the request can be permitted (Step S43). When the request can be permitted, the memory management processor 4 stores information indicating that the memory area is removed from the management target area 31, i.e., the memory area is removed from under the management of the kernel program 32 (Step S44), and writes that the request is permitted as the management-target-area increasing and decreasing permission in the communication buffer 5 (Step S45). When the request cannot be permitted at Step S43, the memory management processor 4 writes that effect at Step S4.5. Then, the communication buffer 5 notifies the management-target-area increasing and decreasing unit 23 that the permission/non-permission is written, and the management-target-area increasing and decreasing unit 23 that receives the notification reads out the permission/non-permission and recognizes the result for the request for deallocating the memory area (Step S46).

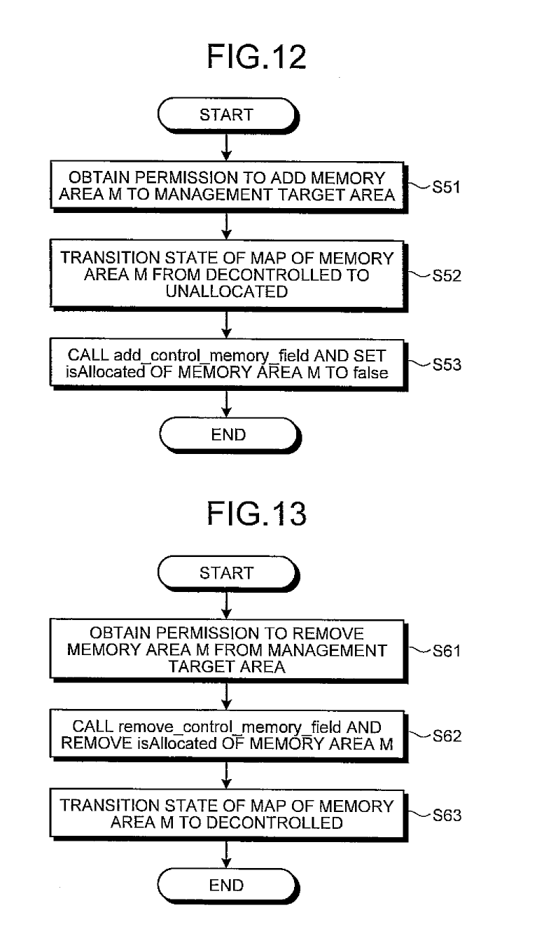

FIG. 12 is a flowchart explaining the operation of adding the requested memory area to the management target area 31 by the management-target-area increasing and decreasing unit 23 when the permission is granted from the memory management processor 4. The memory area to be added to the management target area 31 is expressed as the memory area M. As shown in FIG. 12, first, when the request for adding the memory area M to the management target area 31 is permitted (Step S51), the management-target-area increasing and decreasing unit 23 calls and executes the function that transitions the state of the memory area M from the DECONTROLLED state to the UNALLOCATED state (Step S52). Then, the management-target-area increasing and decreasing unit 23 calls and executes the add_control_memory_field to generate the is Allocated variable of the memory area M and assigns “false” to the generated is Allocated variable (Step S53), and ends the operation of adding the memory area M to the management target area 31. The added memory area M is in a state capable of being allocated to a task by the kernel program 32.

FIG. 13 is a flowchart explaining the operation of removing the requested memory area from the management target area 31 by the management-target-area increasing and decreasing unit 23 when the permission is granted from the memory management processor 4. The memory area to be removed is expressed as the memory area M. As shown in FIG. 13, first, when the request for removing the memory area M from the management target area 31 is permitted (Step S61), the management-target-area increasing and decreasing unit 23 calls and executes the remove_control_memory_field to remove the is Allocated variable of the memory area M (Step S62). Then, the management-target-area increasing and decreasing unit 23 calls and executes the function that transitions the state of the memory area M from the UNALLOCATED state to the DECONTROLLED state (Step S63), and ends the operation of removing the memory area M from the management target area 31. The removed memory area M is removed from under the management of the kernel program 32 and is in a state in which a task cannot use it.

As described above, it is configured to includes the memory allocation managing unit 21, the MAP managing unit 22, the memory allocation management information 33, and the MAP management information 34 as a state managing unit that manage whether the is Allocated variable is “false”, i.e., the UNALLOCATED state (unallocated state), or the is Allocated variable is “true” (allocated state) and further classify the state in which the is Allocated variable is “true” into any one of the PRIVATE state (cache-use-accessible state) in which the read/write access using the cache is possible, the PUBLIC state (cache-nonuse-accessible state) in which the read/write access without using the cache is possible, and the PROTECTED state (read accessible state) in which only the read access is possible, and perform transition between the UNALLOCATED state and the PUBLIC state, between the PUBLIC state and the PRIVATE state, and between the PUBLIC state and the PROTECTED state in accordance with the request from a task (in other words, the processor core included in the multi-core processor 2), for each memory area included in the management target area 31, and the management-target-area increasing and decreasing unit 23 that increases and decreases the management target area 31 by increasing and decreasing the memory area in the UNALLOCATED state in the management target area 31, so that the memory area that can be used by the multi-core processor 2 can be dynamically added/removed while maintaining the cache coherency.

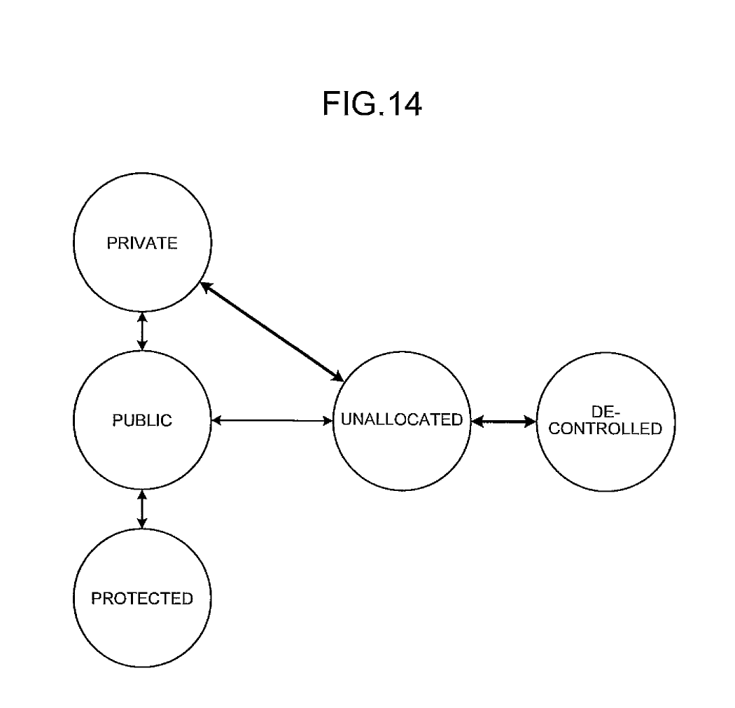

The MAP shown in FIG. 6 can be further extended to make it possible to transition between the UNALLOCATED state and the PRIVATE state as shown in FIG. 14. With the MAP shown in FIG. 6, when the memory area to which a task accesses by using the cache needs to be deallocated from this task, the memory area once needs to transition to the PUBLIC state; however, if the MAP is extended as shown in FIG. 14, the memory area can be deallocated from this task more quickly.

In the above explanation, the MAP in which five states are defined as shown in FIG. 6 is used; however, the states obtained by further subdividing the five states can be defined so long as the cache coherency can be maintained. Moreover, the state other than the five states can be further added.

Moreover, explanation is given in which the memory resources of the management target area 31 are managed in a predetermined unit; however, the size of a management unit of the memory resources is not specifically limited. Furthermore, it is applicable that the memory resources are not managed in a predetermined unit. In other words, the size of each memory area whose state is managed by the memory allocation management information 33 and the MAP management information 34 can be made different from each other.

In the first embodiment, the memory management processor as a dedicated processor has a function of allocating part of the memory resources to the management target area, determining, when the management-target-area increasing and decreasing request is received from the management-target-area increasing and decreasing unit, whether the received request can be permitted, and transmitting, when it is determined that the received request can be permitted, the management-target-area increasing and decreasing permission indicating that the increase and decrease of the management target area is permitted to the management-target-area increasing and decreasing unit; however, this function can be realized on the multi-core processor instead of the dedicated processor.

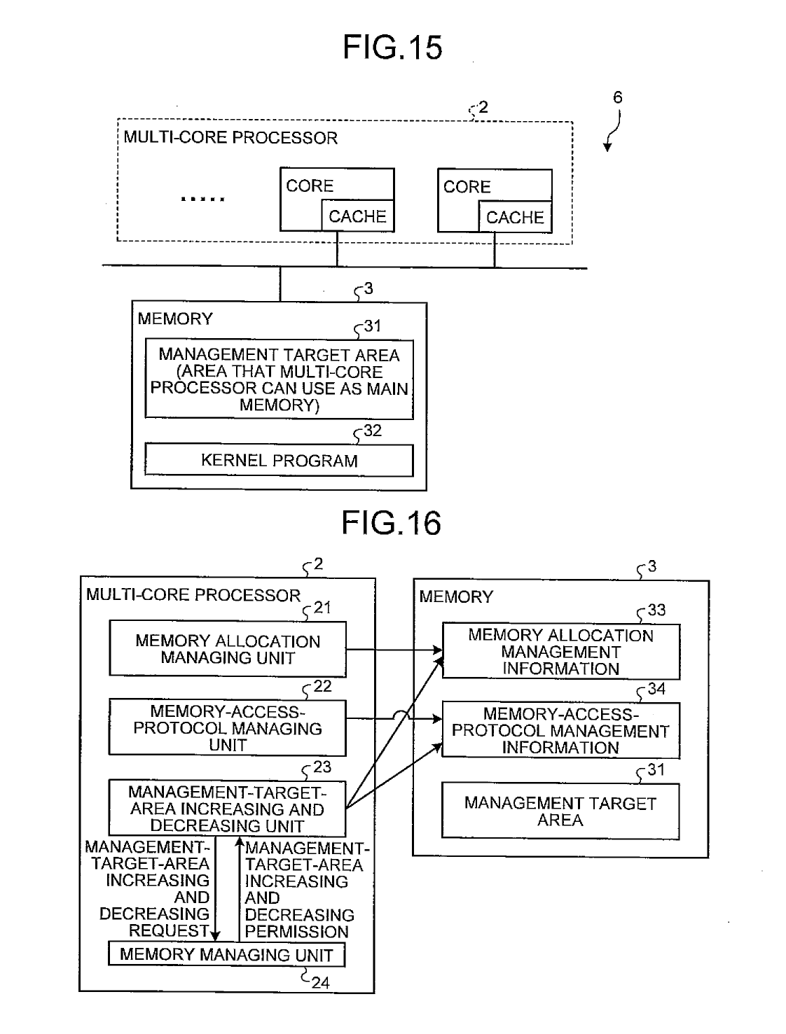

FIG. 15 is a diagram explaining a configuration of a multi-core processor system according to a second embodiment, in which the memory management processor is eliminated and the function of the memory management processor is realized on the multi-core processor. As shown in FIG. 15, in a multi-core processor system 6, the memory management processor, and the communication buffer for performing communication between this memory management processor and the multi-core processor 2 are eliminated. In the memory 3, a kernel program 35 for realizing the function of the memory management processor in addition to the function in the first embodiment is loaded.

FIG. 16 is a diagram explaining a function configuration of the multi-core processor system 6. As shown in FIG. 16, the multi-core processor 2 generates the memory allocation managing unit 21, the memory-access-protocol (MAP) managing unit 22, the management-target-area increasing and decreasing unit 23, and a memory management unit 24 by executing the kernel program 35. The function configuration of the memory 3 and the function of the memory allocation managing unit 21, the MAP managing unit 22, and the management-target-area increasing and decreasing unit 23 are similar to those in the first embodiment. Moreover, the function of the memory management unit 24 is similar to the function of the memory management processor 4 in the first embodiment.

In this manner, according to the second embodiment, the function of allocating the management target area 31 is realized on the multi-core processor 2, so that the dedicated processor for this function and the communication buffer 5 used for communication between the processor and the multi-core processor 2 can be eliminated. Thus, the manufacturing cost and the chip area can be reduced.

While certain embodiments have been described, these embodiments have been presented by way of example only, and are not intended to limit the scope of the inventions. Indeed, the novel processors and systems described herein may be embodied in a variety of other forms; furthermore, various omissions, substitutions and changes in the form of the processors and systems described herein may be made without departing from the spirit of the inventions. The accompanying claims and their equivalents are intended to cover such forms or modifications as would fall within the scope and spirit of the inventions.

What is claimed is:

1. A multi-core processor that includes a plurality of processor cores that each includes a cache and that uses a management target area allocated as a main memory in a memory area, comprising:
a state managing unit that, for each small area included in the management target area, manages a first state in which the small area is not allocated to the processor core and a second state in which the small area is allocated to the processor core, further classifies the small area in the second state into a plurality of states in which permission and non-permission of an access and permission and non-permission of use of the cache at a time of an access are defined, and manages a transition between classified states; and
a management-target-area increasing and decreasing unit that increases and decreases the management target area by increasing and decreasing the small area in the first state in the management target area.

2. The multi-core processor according to claim 1, wherein the management-target-area increasing and decreasing unit generates a management-target-area increasing and decreasing request for requesting a transition between a sixth state of an area that is not allocated as the main memory and the first state to increase and decrease the small area in the first state in the management target area.

3. The multi-core processor according to claim 2, further comprising a memory management unit that manages the memory area that includes the area that is not allocated as the main memory, wherein
the memory management unit permits the transition between the sixth state of the area that is not allocated as the main memory and the first state in accordance with the management-target-area increasing and decreasing request generated by the management-target-area increasing and decreasing unit.

4. The multi-core processor according to claim 2, wherein
the classified states includes
a third state in which a read/write access using the cache is permitted,
a fourth state in which the read/write access without using the cache is permitted, and
a fifth state in which only a read access is permitted, and
the state managing unit manages a transition between the first state and the fourth state, a transition between the fourth state and the third state, and a transition between the fourth state and the fifth state.

5. The multi-core processor according to claim 4, wherein the state managing unit manages a transition between the first state and the third state.

6. The multi-core processor according to claim 4, wherein the state managing unit includes a memory-access-protocol managing unit that manages memory-access-protocol management information in which whether the small area in the second state is in the third state, the fourth state, or the fifth state is written.

7. The multi-core processor according to claim 6, wherein the memory-access-protocol managing unit manages the sixth state of the area that is not allocated as the main memory with the memory-access-protocol management information.

8. The multi-core processor according to claim 1, wherein the state managing unit includes a memory allocation managing unit that manages memory allocation management information in which whether the small area is in the first state or the second state is written for each small area included in the management target area.

9. The multi-core processor according to claim 1, wherein
the classified states includes
a third state in which a read/write access using the cache is permitted,
a fourth state in which the read/write access without using the cache is permitted, and
a fifth state in which only a read access is permitted, and
the state managing unit manages a transition between the first state and the fourth state, a transition between the fourth state and the third state, and a transition between the fourth state and the fifth state.

10. The multi-core processor according to claim 9, wherein the management-target-area increasing and decreasing unit generates a management-target-area increasing and decreasing request for requesting a transition between a sixth state of an area that is not allocated as the main memory and the first state to increase and decrease the small area in the first state in the management target area.

11. A multi-core processor system comprising:
a memory area; and
a multi-core processor that includes a plurality of processor cores that each includes a cache and that uses a management target area allocated as a main memory in the memory area, wherein
the multi-core processor includes
a state managing unit that, for each small area included in the management target area, manages a first state in which the small area is not allocated to the processor core and a second state in which the small area is allocated to the processor core, further classifies the small area in the second state into a plurality of states in which permission and non-permission of an access and permission and non-permission of use of the cache at a time of an access are defined, and manages a transition between classified states, and
a management-target-area increasing and decreasing unit that increases and decreases the management target area by increasing and decreasing the small area in the first state in the management target area.

12. The multi-core processor system according to claim 11, wherein the management-target-area increasing and decreasing unit generates a management-target-area increasing and decreasing request for requesting a transition between a sixth state of an area that is not allocated as the main memory and the first state to increase and decrease the small area in the first state in the management target area.

13. The multi-core processor system according to claim 12, further comprising a memory management unit that manages the memory area that includes the area that is not allocated as the main memory, wherein
the memory management unit permits the transition between the sixth state of the area that is not allocated as the main memory and the first state in accordance with the management-target-area increasing and decreasing request generated by the management-target-area increasing and decreasing unit.

14. The multi-core processor system according to claim 12, wherein
the classified states includes
a third state in which a read/write access using the cache is permitted,
a fourth state in which the read/write access without using the cache is permitted, and
a fifth state in which only a read access is permitted, and
the state managing unit manages a transition between the first state and the fourth state, a transition between the fourth state and the third state, and a transition between the fourth state and the fifth state.

15. The multi-core processor system according to claim 14, wherein the state managing unit manages a transition between the first state and the third state.

16. The multi-core processor system according to claim 14, wherein the state managing unit includes a memory-access-protocol managing unit that manages memory-access-protocol management information in which whether the small area in the second state is in the third state, the fourth state, or the fifth state is written.

17. The multi-core processor system according to claim 16, wherein the memory-access-protocol managing unit manages the sixth state of the area that is not allocated as the main memory with the memory-access-protocol management information.

18. The multi-core processor system according to claim 11, wherein the state managing unit includes a memory allocation managing unit that manages memory allocation management information in which whether the small area is in the first state or the second state is written for each small area included in the management target area.

19. The multi-core processor system according to claim 11, wherein
the classified states includes
a third state in which a read/write access using the cache is permitted,
a fourth state in which the read/write access without using the cache is permitted, and
a fifth state in which only a read access is permitted, and
the state managing unit manages a transition between the first state and the fourth state, a transition between the fourth state and the third state, and a transition between the fourth state and the fifth state.

20. The multi-core processor system according to claim 19, wherein the management-target-area increasing and decreasing unit generates a management-target-area increasing and decreasing request for requesting a transition between a sixth state of an area that is not allocated as the main memory and the first state to increase and decrease the small area in the first state in the management target area.
